(19) United States
(12) Patent Application Publication
(10) Pub. No.: US 2014/0340404 A1
(43) Pub. Date: Nov. 20, 2014

(54) METHOD AND APPARATUS FOR GENERATING 3D FREE VIEWPOINT VIDEO

(71) Applicants: Meng Wang, Vancouver (CA); Lin Du, Beijing (CN); Xiaojun Ma, Beijing (CN)

(72) Inventors: Meng Wang, Vancouver (CA); Lin Du, Beijing (CN); Xiaojun Ma, Beijing (CN)

(73) Assignee: Thomson Licensing, Issy de Moulineaux (FR)

(21) Appl. No.: 14/365,240

(22) PCT Filed: Dec. 16, 2011
(86) PCT No.: PCT/CN2011/084132

§ 371 Date: Jun. 13, 2014

(51) Int. Cl. H04N 13/00; G06T 15/20

(52) U.S. Cl. CPC H04N 13/0014; G06T 15/20; G06T 2207/10021
USPC 345/427

(57) ABSTRACT

The present invention relates to a method for generating 3D viewpoint video content. The method comprising the steps of receiving videos shot by cameras distributed to capture an object; forming a 3D graphic model of at least part of the scene of the object based on the videos; receiving information related to viewpoint and 3D region of interest (ROD in the object; and combining the 3D graphic model and the videos related to the 3D ROI to form a hybrid 3D video content.

### FIELD OF THE INVENTION

The present invention relates to method and apparatus for generating 3D free-viewpoint video.

### BACKGROUND OF THE INVENTION

The 3D live broadcasting service with free viewpoints has been attracting a lot of interest from both industry and academic fields. With this service, a user can watch the 3D video from any user-selected viewpoints, which gives a user great experience on watching 3D video and provides lots of possibilities of virtual 3D interactive applications.

One conventional solution for achieving the 3D live broadcasting service with free viewpoints is to install cameras on all the popular viewpoints and to simply switch the video streams according to users' selection on viewpoints. Obviously cost for achieving this solution is very expensive and almost not portable at all as it needs to install lots of cameras if a service provider wants to provide enjoyable free viewpoint 3D video to users.

Recent technology advancement has introduced two other solutions for this service, namely 3D model reconstruction and 3D view synthesis. The 3D model reconstruction approach generally includes 8 steps of process for each video frame, that is, 1) capturing multi-view video frames using cameras installed around the target, 2) finding the corresponding pixels from each view using image matching algorithms, 3) calculating the disparity of each pixel and generating the disparity map for any adjacent views, 4) working out the depth value of each pixel using the disparity and camera calibration parameters, 5) re-generating all the pixels with their depth value in 3D space to form a point cloud, 6) estimating the 3D mesh using the point cloud, 7) merging the texture from all the views and attaching to the 3D mesh to form a whole graphic model, and 8) finally rendering the graphic model at user terminal using the selected viewpoint. This 3D model reconstruction approach can achieve free viewpoint smoothly but the rendering results look artificial and are not as good as the video directly captured by cameras.

The other solution, 3D view synthesis approach, tries to solve the problem through view interpolation algorithms. By applying some mathematical transformations for the interpolation of the intermediate views from adjacent cameras, the virtual views can be directly generated. This 3D view synthesis approach can achieve better perceptive results if the cameras are uniformly distributed and carefully calibrated, but realistic mathematical transformations are usually difficult and require some computation power at user terminal.

A method for synthesizing 2D free viewpoint image is shown in the technical paper: Kunihiro Hayashi and Hideo Saito, “Synthesizing free-viewpoint images from multiple view videos in soccer stadium”, Proceedings of the

International Conference on Computer Graphics, Imaging and Visualization (CGIV′06), IEEE, 2006.

### SUMMARY OF THE INVENTION

These and other drawbacks and disadvantages of the above mentioned related art are addressed by the present invention.

According to an aspect of the present invention, there is provided a method for generating 3D viewpoint video content, the method comprising the steps of receiving videos shot by cameras distributed to capture an object; forming a 3D graphic model of at least part of the scene of the object based on the videos; receiving information related to viewpoint and 3D region of interest (ROI) in the object; and combining the 3D graphic model and the videos related to the 3D ROI to form a hybrid 3D video content.

According to another aspect of the present invention, there is provided a method for presenting a hybrid 3D video content including a 3D graphic model and videos related to a 3D region of interest (ROI), the method comprising the steps of receiving the hybrid 3D video content; retrieving the 3D graphic model and the videos related to the 3D ROI in the hybrid 3D video content; rendering each video frame of the 3D graphic model; synthesizing virtual 3D views in a video frame related to the 3D ROI; merging the synthesized virtual 3D views in the video frame on the 3D graphic model in the corresponding video frame to form the final view for the frame; and presenting the final view on a display.

### BRIEF DESCRIPTION OF DRAWINGS

These and other aspects, features and advantages of the present invention will become apparent from the following description in connection with the accompanying drawings in which:

FIG. 1 illustrates an exemplary block diagram of a system for broadcasting 3D live free viewpoint video according to an embodiment of the present invention;

FIG. 2 illustrates an exemplary block diagram of the head-end according to an embodiment of the present invention;

FIG. 3 illustrates an exemplary block diagram of the user terminal according to an embodiment of the present invention;

FIGS. 4 and 5 illustrate an example of the implementation of the system according to an embodiment of the present invention;

FIG. 6 is a flow chart showing a process for generating 3D live free viewpoint video content;

FIG. 7 is a flow chart showing the process for creating the 3D graphic model; and

FIG. 8 is a flow chart showing the process for presenting the hybrid 3D video content.

### DETAIL DESCRIPTION OF PREFERRED EMBODIMENTS

In the following description, various aspects of an embodiment of the present invention will be described. For the purpose of explanation, specific configurations and details are set forth in order to provide a thorough understanding. However, it will also be apparent to one skilled in the art that the present invention may be practiced without the specific details present herein.

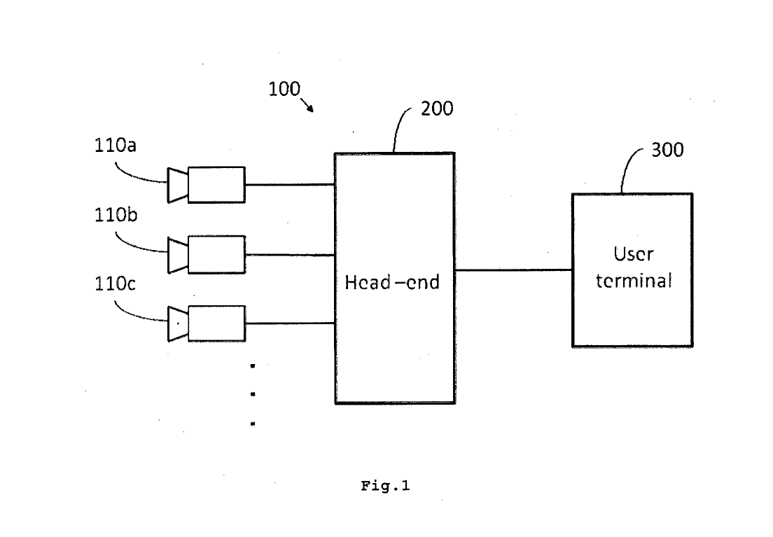

FIG. 1 illustrates an exemplary block diagram of a system 100 for broadcasting 3D live free viewpoint video according to an embodiment of the present invention. The system 100 may comprise a head-end 200 and at least one user terminal 300 connected to the head-end 200 via a wired or wireless network such as Wide Area Network (WAN). Video cameras 110a, 110b, 110c (referred to as “110” hereinafter) are connected to the head-end 200 via a wired or wireless network such as Local Area Network (LAN). The number of the video cameras may depend on an object to capture.

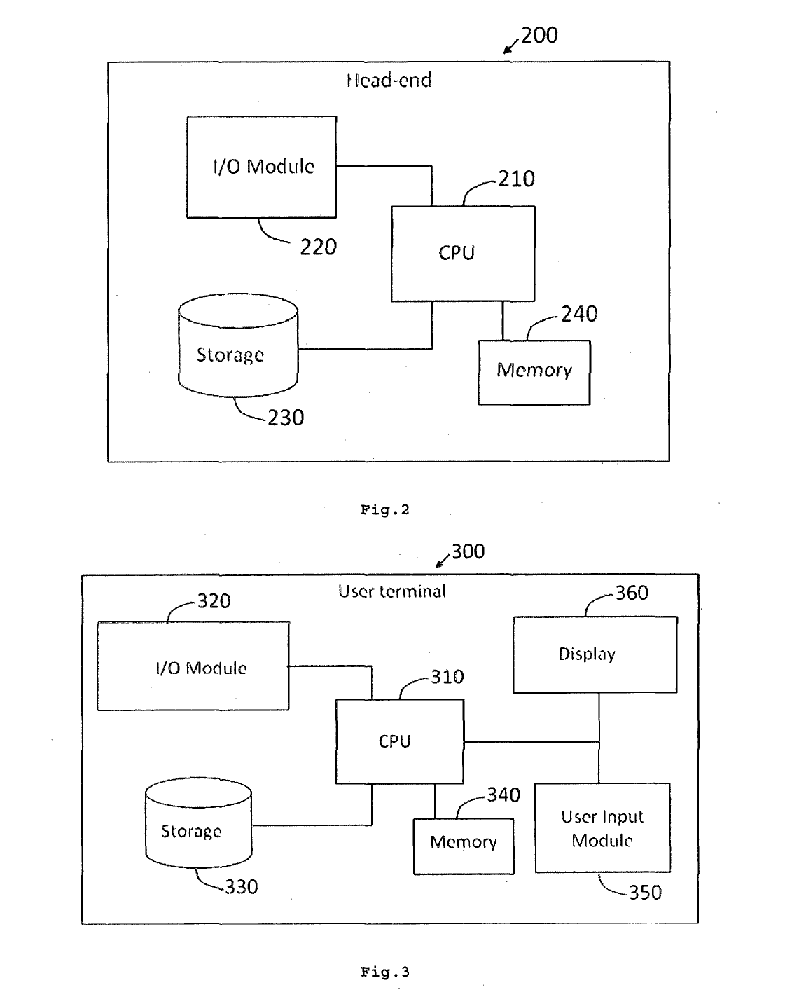

FIG. 2 illustrates an exemplary block diagram of the head-end 200 according to an embodiment of the present invention. As shown in FIG. 2, the head-end 200 comprises a CPU (Central Processing Unit) 210, an I/O (Input/Output) module 220 and storage 230. A memory 240 such as RAM (Random Access Memory) is connected to the CPU 210 as shown in FIG. 2.

The I/O module 220 is configured to receive video image data from cameras 110 connected to the I/O module 220. Also the I/O module 220 is configured to receive information such as user's selection on viewpoint and 3D region of interest (ROI), screen resolution of the display in the user terminal 300, processing power of the user terminal 300 and other parameters of the user terminal 300 and to transmit video content generated by the head-end 200 to the user terminal 300.

The storage 230 is configured to store software programs and data for the CPU 210 of the head-end 200 to perform the process which will be described below.

FIG. 3 illustrates an exemplary block diagram of the user terminal 300 according to an embodiment of the present invention. As shown in FIG. 3, the user terminal 300 also comprises a CPU (Central Processing Unit) 310, an I/O module 320, storage 330 and a memory 340 such as RAM (Random Access Memory) connected to the CPU 310. The user terminal 300 further comprises a display 360 and a user input module 350.

The I/O module 320 in the user terminal 300 is configured to receive video content transmitted by the head-end 200 and to transmit information such as user's selection on viewpoint and region of interest (ROI), screen resolution of the display in the user terminal 300, processing power of the user terminal 300 and other parameters of the user terminal 300 to the head-end 200.

The storage 330 is configured to store software programs and data for the CPU 310 of the user terminal 300 to perform the process which will be described below.

The display 360 is configured so that it can present 3D video content provided by the head-end 200. The display 360 can be a touch-screen so that it can provide a possibility to the user to input on the display 360 the user's selection on viewpoint and 3D region of interest (ROI) in addition to the user input module 350.

The user input module 350 may be a user interface such as keyboard, a pointing device like a mouse and/or a remote controller to input the user's selection on viewpoint and region of interest (ROI). The user input module 350 can be an option if the display 360 is a touch-screen and the user terminal 300 is configured so that such user's selection can be input on the display 360.

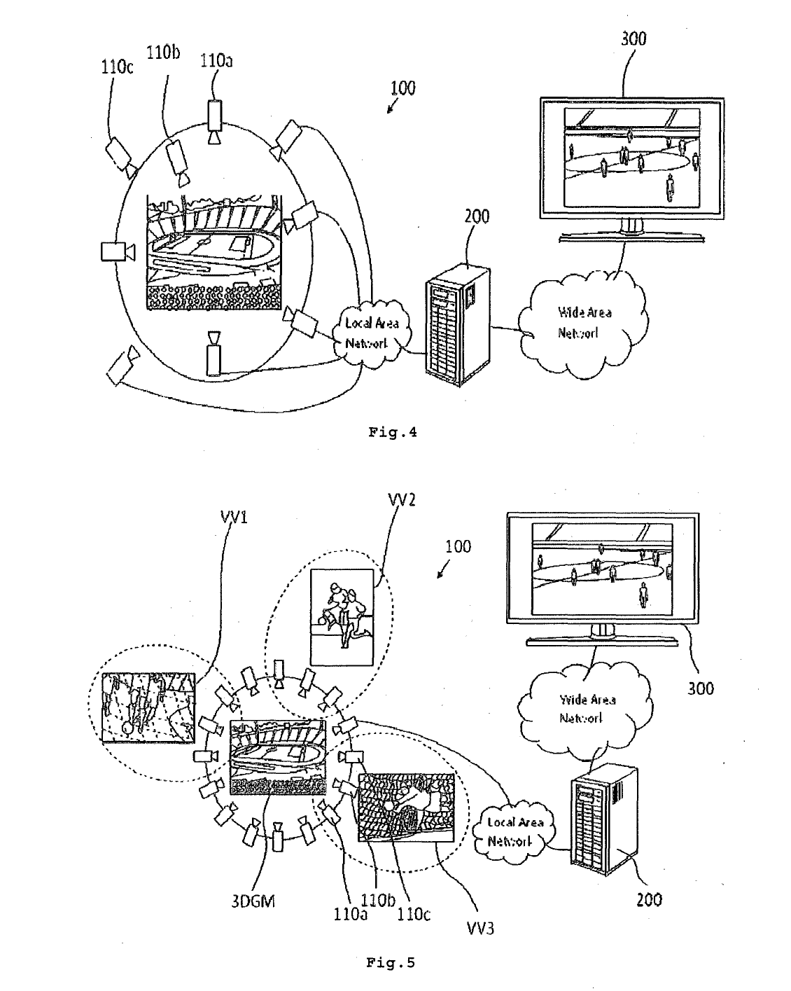

FIGS. 4 and 5 illustrate an example of the implementation of the system 100 according to an embodiment of the present invention. FIGS. 4 and 5 illustratively show that the system 100 is applied to broadcasting 3D live free viewpoint video for soccer game. As can be seen in FIGS. 4 and 5, cameras 110 are preferably distributed so that cameras 110 surround a soccer stadium. The head-end 200 can be installed in a room in the stadium and the user terminal 300 can be located at user's home, for example.

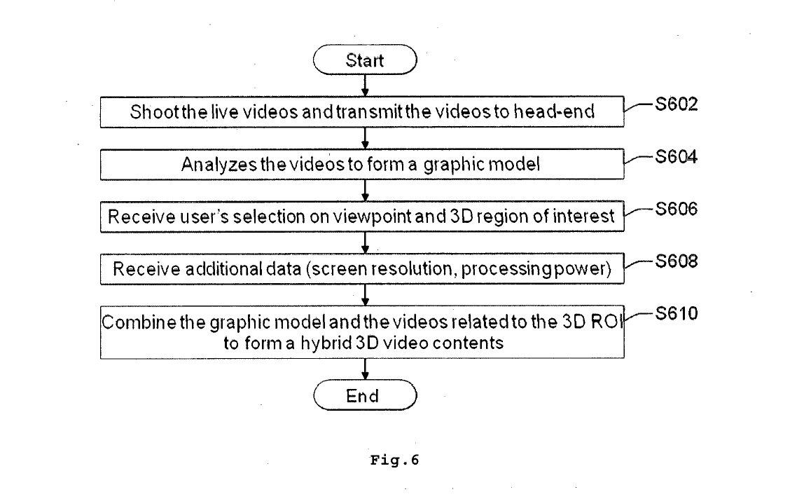

FIG. 6 is a flow chart showing a process for generating 3D live free viewpoint video content. The method will be described below with reference to FIGS. 1 to 6.

At step 602, each of the on-site cameras 100 shoot the live videos from different viewpoints and those live videos are transmitted to the head-end 200 via a network such as Local Area Network (LAN). In this step, for example, a video of a default view point shot by a certain camera 110 is transmitted from the head-end 200 to the user terminal 300 and the video is displayed on the display 360 so that a user can select at least one of 3D region on interest (ROI) on the display 360. The region of interest can be a soccer player on the display 360 in this example.

At step 604, the CPU 210 of the head-end 200 analyzes the videos using the calibrated camera parameters to form a graphic model of the whole or at least part of the scene of the stadium. The calibrated camera parameters are related to the locations and orientations of the cameras 110. For example, the calibration for each camera can be realized by capturing a reference chart such as a mesh-like chart by each camera and by analyzing the respective captured image of the reference chart. The analysis may include analyzing the size and the distortion of the reference chart captured in the image. The calibrated camera parameters can be obtained by performing camera calibration using the onsite cameras 110 and are preliminarily stored in the storage 230.

At step 606, the head-end 200 receives the user's selection on viewpoint and 3D region of interest (ROI). The user's selection can be input by the user input module 350 and/or the display 360 of the user terminal 300. The user's selection on viewpoint can be achieved by selecting a viewpoint using arrow keys on remote controller, by pointing a viewpoint using pointing device or any other possible methods. For example, if the user wants to see a scene of a diving save by goalkeeper, the user can select the viewpoint towards the goalkeeper. Also, the user's selection on 3D region of interest (ROI) can be achieved by circling a pointer around an interesting object or area on the display 360 using the user input module 350 or directly on the display 360 if it is a touch-screen.

If a user does not select the viewpoint, the CPU 210 of the head-end 200 then selects a default viewpoint with a certain camera 110. Also, if a user does not specify 3D ROI, the CPU 210 of the head-end 200 then analyzes the video of the selected or default viewpoint to estimate the possible 3D ROI within the scene of the video. The process for estimating possible 3D ROI within the scene of the video can be performed using a conventional ROI detection methods as mentioned in the technical paper: Xinding Sun, Jonathan Foote, Don Kimber and B. S. Manjunath, “Region of Interest Extraction and Virtual Camera Control Based on Panoramic Video Capturing”, IEEE Transactions on Multimedia, 2005.

As described above, the head-end 200 acquires information related to the user's selection on the viewpoint and the 3D ROI or the default viewpoint and the estimated 3D ROI.

At step 608, the head-end 200 may receive additional data including the screen resolution of the display 360, processing power of the CPU 310 and any other parameters of the user terminal 300 to transmit proper content to the user terminal 300 in accordance with such additional data. Such data are preliminarily stored in the storage 330 of the user terminal 300.

At step 610, the CPU 210 of the head-end 200 then encodes the graphic model of the stadium seen from the selected or default viewpoint and the videos related to the selected or estimated 3D ROI which videos are shot by at least two cameras 110 located close to the user's selected or default viewpoint to form a hybrid 3D video content with proper level of detail (resolution) according to the additional data regarding the user terminal 300. The graphic model and the videos related to the 3D ROI is encoded and combined in the hybrid 3D video content.

For example, if the display 360 has high resolution and the CPU 310 has high processing power, hybrid 3D video content with high level of detail can be transmitted to the user terminal 300. In the reverse situation, the level of detail of the hybrid 3D video content to be transmitted to the user terminal 300 can be reduced in order to save network bandwidth on the network between the head-end 200 and the user terminal 300 and processing load on the CPU 310. The level of detail of the hybrid 3D video content to be transmitted to the user terminal 300 can be determined by the CPU 210 of the head-end 200 based on the additional data regarding the user terminal 300.

In general, it is known that a 3D graphic model is formed from points so-called “vertex” which define the shape and forming “polygons” and that the 3D graphic model is generally rendered in a 2D representation. In this illustrative example, the graphic model of the hybrid 3D video content is a 3D graphic model which will be presented on the display 360 on the user terminal 300 as a 2D representation as a background, whereas virtual 3D views, which will be generated by the videos related to the selected or estimated 3D ROI, will be presented on the background 3D graphic model in the display 360 as a 3D representation (stereoscopic representation) having right and left views. In this example, the 3D graphic model rendered in the 2D representation as the background is related to the scene of the soccer stadium and the 3D ROI rendered in the 3D representation on the background is related to the soccer player.

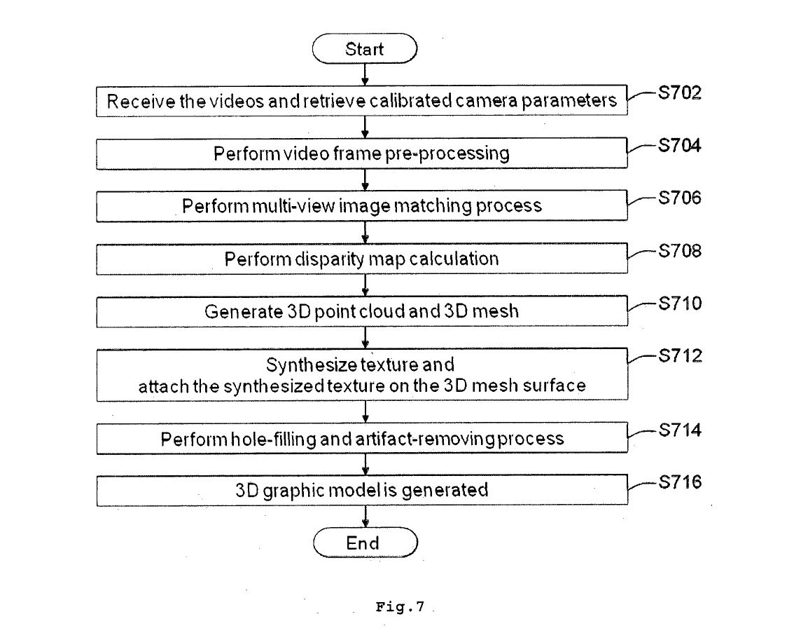

FIG. 7 is a flow chart showing the process for creating the 3D graphic model. The process for creating the 3D graphic model will be discussed below with reference to FIGS. 2, 5 and 7.

At first, videos shot by on-site cameras 110 are received via I/O module 220 of the head-end 200 and the calibrated camera parameters are retrieved from the storage 230 (S702). Then, video frame pre-processing such as image rectification for the videos is performed by the CPU 210 (S704).

Following this step, by the CPU 210, multi-view image matching process is performed to find the corresponding pixels in videos of adjacent views (S706), disparity map calculation is performed for those videos of adjacent views (S708) and 3D point cloud and 3D mesh are generated based on the disparity map created in step 708 (S710).

Then, texture is synthesized based on video images from all or at least part of the views and the synthesized texture is attached on the 3D mesh surface by the CPU 210 (S712). Finally, hole-filling and artifact-removing process is performed by the CPU 210 (S714). In this process, the 3D graphic model is generated (S716). In this example, the 3D graphic model is an entire view of the soccer stadium as shown in FIG. 5 with reference symbol “3DGM”.

A conventional 3D graphic model reconstruction process is mentioned in the technical paper: Noah Snavely, Ian Simon, Michael Goesele, Richard Szeliski and Steven M. Seitz, “Scene Reconstruction and Visualization From Community Photo Collections”, Proceedings of the IEEE, Vol. 98, No. 8, August 2010, pp. 1370-1390.

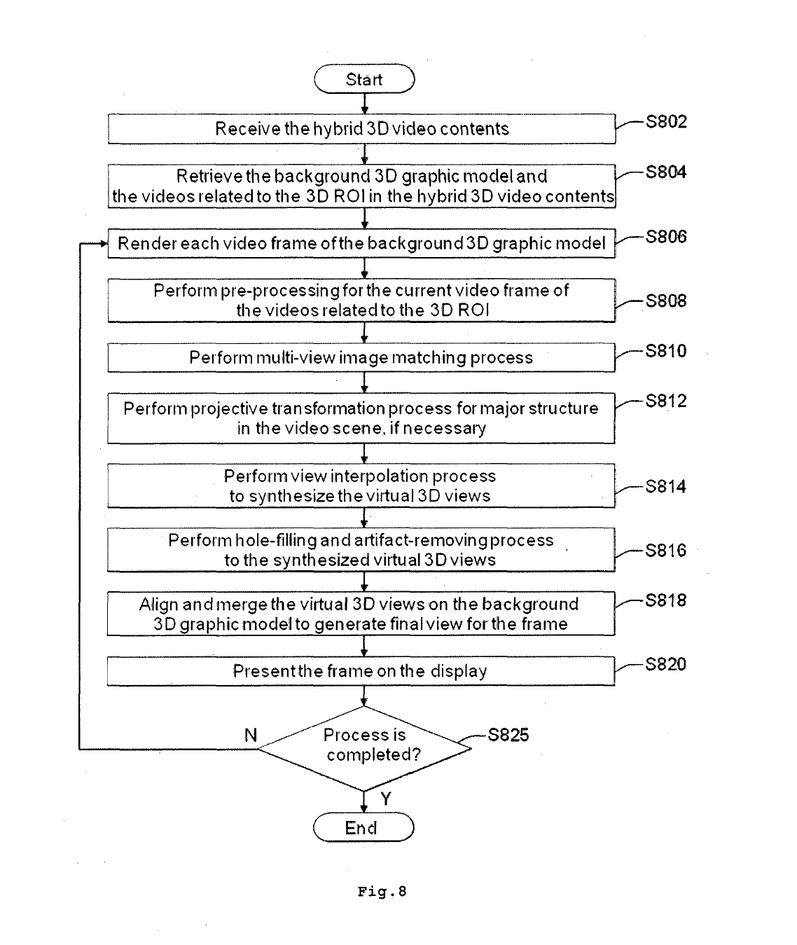

FIG. 8 is a flow chart showing the process for presenting the hybrid 3D video content. The process for reproducing the hybrid 3D video content will be discussed below with reference to FIGS. 3 and 7.

At first, the I/O module 320 of the user terminal 300 receives the hybrid 3D video content from the head-end 200 (S802).

Then, the CPU 310 of the user terminal 300 decodes the background 3D graphic model seen from the selected or default viewpoint and the videos related to the selected or estimated 3D ROI in the hybrid 3D video content (S804), as a result of this, the background 3D graphic model and the videos related to the 3D ROI are retrieved. Then the CPU 310 renders each video frame of the background 3D graphic model seen from the selected or default viewpoint (S806).

Next, video frame pre-processing such as image rectification is performed by the CPU 310 for the current video frame of the videos related to the selected or estimated 3D ROI for synthesizing the virtual 3D views in the selected or default viewpoint (S808).

Following to the step 808, multi-view image matching process is performed by the CPU 310 to find the corresponding pixels in the videos of adjacent views (S810). If necessary, projective transformation process for major structure in the video scene may be performed by the CPU 310 after the step 810 (S812).

Then, view interpolation process is performed by the CPU 310 to synthesize the virtual 3D views in the selected or default viewpoint using a conventional pixel level interpolation techniques, for example (S814) and hole-filling and artifact-removing process to the synthesized virtual 3D views is performed by the CPU 310 (S816). In the step 814, two virtual 3D views are synthesized if the virtual 3D views are generated for stereoscopic 3D representation and more than two virtual 3D views are synthesized if the virtual 3D views are generated for multi-view 3D representation. Virtual 3D views are illustratively shown in FIG. 5 with reference symbols “VV1, VV2 and VV3”.

A conventional view interpolation process is mentioned in the technical paper: S. Chen and L. Williams, “View Interpolation for Image Synthesis”, ACM SIGGRAPH'93, pp. 279-288, 1993.

Finally, by the CPU 310, the virtual 3D views are aligned and merged on the background 3D graphic model with the same perspective parameters to generate final view for the frame of the hybrid 3D video content (S818) and this frame is displayed on the display 360 (S820).

At step 825, if the process for all video frames of the hybrid 3D video content to be presented is completed, this process will be terminated. If not, the CPU 310 will start to the process of steps 808-820 for next video frame.

User can change the user's selection on viewpoint and 3D region of interest (ROI) at the user terminal 300 during the hybrid 3D video content is presented on the display 360. When the user's selection on viewpoint and 3D region of interest (ROI) is changed, the above-described process will be performed according to the new user's selection.

The above-described example is discussed in the context of that the background 3D graphic model is presented on the display 360 as a 2D representation and the virtual 3D views is presented on the display 360 as a 3D representation. However, the system 100 can be configured to present both the background 3D graphic model and the virtual 3D views on the display 360 as a 3D representation if it is possible in view of the conditions such as the bandwidth of the network and the processing load on the head-end 200 and the user terminal 300. Also, the system 100 can be configured to present both the background 3D graphic model and a virtual view on the display 360 as a 2D representation.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for generating 3D viewpoint video content, the method comprising:
receiving videos in which an object is captured;
forming a 3D graphic model of at least part of the scene of the object based on the videos;
acquiring information related to viewpoint and 3D region of interest (ROI) in the object; and
combining the 3D graphic model and the videos related to the 3D ROI to form a hybrid 3D video content.

2. The method according to claim 1, wherein the method further comprising receiving additional data to determine the level of details of the hybrid 3D video content to be formed.

3. A method for presenting a hybrid 3D video content including a 3D graphic model and videos related to a 3D region of interest (ROI), the method comprising:
receiving the hybrid 3D video content;
retrieving the 3D graphic model and the videos related to the 3D ROI in the hybrid 3D video content;
rendering each video frame of the 3D graphic model;
synthesizing virtual 3D views in a video frame related to the 3D ROI;
merging the synthesized virtual 3D views in the video frame on the 3D graphic model in the corresponding video frame to form the a final view for the video frame; and
presenting the final view on a display.

4. The method according to claim 3, wherein the 3D graphic model is presented on the display in 2D representation and the virtual 3D views are presented on the display in 3D representation.

5. The method according to claim 3, wherein the rendering, synthesizing and presenting are repeated.

6. The method according to claim 3, wherein the merging includes aligning the virtual 3D views with the 3D graphic model with the same perspective parameters.

7. An apparatus for generating 3D viewpoint video content, the apparatus comprising:
a processor configured to:
receive videos in which an object is captured;
form a 3D graphic model of at least part of the scene of the object based on the videos;
acquire information related to viewpoint and 3D region of interest (ROI) in the object; and
combine the 3D graphic model and the videos related to the 3D ROI to form a hybrid 3D video content.

8. The apparatus according to claim 7, wherein the processor is further configured to receive additional data to determine the level of details of the hybrid 3D video content to be formed.

9. An apparatus for presenting a hybrid 3D video content including a 3D graphic model and videos related to a 3D region of interest (ROI), the apparatus comprising:
a display; and
a processor configured to:
receive the hybrid 3D video content;
retrieve the 3D graphic model and the videos related to the 3D ROI in the hybrid 3D video content;
render each video frame of the 3D graphic model;
synthesize virtual 3D views in a video frame related to the 3D ROI;
merge the synthesized virtual 3D views in the video frame on the 3D graphic model in the corresponding video frame to form a final view for the video frame; and
present the final view on the display.

10. The apparatus according to claim 9, wherein the processor is further configured to present on the display the 3D graphic model in 2D representation and the virtual 3D views in 3D representation.

11. The apparatus according to claim 9, wherein the processor is further configured to align the virtual 3D views with the 3D graphic model with the same perspective parameters.
